(19) United States
(12) Patent Application Publication
(10) Pub. No.: US 2025/0132699 A1
(43) Pub. Date: Apr. 24, 2025

(54) VEHICLE, IN PARTICULAR A TWO-WHEELER OR THREE-WHEELER

(71) Applicant: Robert Bosch GmbH, Stuttgart (DE)

(72) Inventors: Alessandro Moia, Holzgerlingen (DE); Silas Klug, Magstadt (DE)

(21) Appl. No.: 18/705,009

(22) PCT Filed: Dec. 15, 2022
(86) PCT No.: PCT/EP2022/086069

§ 371 Date: Apr. 26, 2024

(30) Foreign Application Priority Data
Feb. 7, 2022 (DE) 10 2022 201 244.5

(51) Int. Cl. H02P 3/22; B60L 7/02

(52) U.S. Cl. CPC H02P 3/22; B60L 7/02; B60L 2200/12

(57) ABSTRACT

A vehicle, in particular a two-wheeler or three-wheeler. The vehicle includes at least one electric motor which is provided for decelerating the vehicle and/or at least one vehicle wheel of the vehicle during a braking operation, and at least one vehicle battery which is functionally coupled to the electric motor. The vehicle has a braking chopper unit which is operatively connected to the electric motor and the vehicle battery, has at least one braking resistor, and is provided for dissipating excess energy generated by the electric motor during the braking operation.

### FIELD

The present invention relates to a vehicle, in particular a two-wheeler or three-wheeler. The present invention also relates to a method for operating such a vehicle.

### BACKGROUND INFORMATION

Two-wheelers or three-wheelers, in particular motorcycles, which comprise an electric motor and a vehicle battery functionally coupled to the electric motor are described in the related art, such as in German Patent Application No. DE 10 2012 209 223 A1. The electric motor can be used on the one hand to drive at least one vehicle wheel of the vehicle and on the other hand to decelerate at least one vehicle wheel of the vehicle. A significant advantage of electromobility is the ability to convert the kinetic energy of the vehicle into electrical energy during a braking operation by means of the electric motor and store said kinetic energy in the vehicle battery. This process is also known as recuperation. However, the braking power in this case is heavily dependent on the temperature and state of charge of the vehicle battery. Accordingly, if the vehicle battery is too cold, too hot, or has too high a state of charge, it can absorb very little or no energy, as a result of which the electric motor cannot decelerate the vehicle, or can only do so insufficiently. In many driving situations, the vehicle battery is therefore the bottleneck for a maximum braking power which the vehicle can regeneratively convert.

An object of the present invention is in particular to provide a vehicle with improved properties with regard to braking functionality. The object may be achieved by the features of the present invention, Advantageous embodiments and developments of the present invention are disclosed herein.

### SUMMARY

The present invention relates to a vehicle comprising at least one electric motor which is provided for decelerating the vehicle and/or at least one vehicle wheel of the vehicle during a braking operation, and comprising at least one vehicle battery which is functionally coupled to the electric motor, in particular in the form of an accumulator.

According to an example embodiment of the present invention, the vehicle has a braking chopper unit which is operatively connected to the electric motor and the vehicle battery, has at least one braking resistor, and is provided for dissipating excess energy generated by the electric motor during the braking operation. This design can improve braking functionality, in particular electrical braking functionality. In particular, the availability of the braking functionality provided by the electric motor can be increased and/or an advantageously reproducible generative braking behavior can be achieved, in particular independently of the current temperature and/or current state of charge of the vehicle battery. In addition, the recuperation potential of the vehicle can be fully utilized. In addition, value-added functions, for example in the form of a hill start functionality, an auto-hold functionality and/or a CBS functionality, can be realized.

The vehicle could, for example, be designed as a passenger car or a commercial vehicle. However, the vehicle is preferably different from a conventional passenger car or commercial vehicle. Preferably, the vehicle is designed as a lightweight motor vehicle, such as a quad bike, and particularly preferably as a two-wheeler or three-wheeler, such as a moped, motorcycle and/or motortricycle.

Furthermore, the electric motor is operated in particular as a generator during the braking operation and is provided for generating a recuperative braking torque. In this context, the electric motor is provided in particular for converting kinetic energy from the vehicle into electrical energy and transferring it to the vehicle battery for storage in the vehicle battery. Preferably, according to an example embodiment of the present invention, the electric motor is assigned to exactly one vehicle wheel of the vehicle, preferably a vehicle wheel designed as a rear wheel. Furthermore, the at least one vehicle wheel is preferably not assigned a hydraulic brake, for example in the form of a wheel brake cylinder, so that only the electric motor is provided for decelerating the at least one vehicle wheel during the braking operation. The electric motor could be designed purely as a brake motor. However, in at least one operating state, the electric motor is particularly preferably also provided for driving the vehicle and/or the at least one vehicle wheel. In addition, the term “excess energy” is to be understood in particular as energy which is generated by the electric motor during the braking operation and cannot be absorbed and/or stored by the vehicle battery, for example due to a current state of charge and/or a current temperature of the vehicle battery. Furthermore, a “braking chopper unit” is to be understood in particular as a functional unit which is provided for dissipating or converting into heat excess energy which is generated during deceleration of the vehicle and/or the at least one vehicle wheel and in particular during associated regenerative operation of the electric motor. For this purpose, the braking chopper unit comprises at least one external and/or integrated braking resistor. In addition, the braking chopper unit can comprise at least one heat sink associated with the braking resistor. In principle, the braking chopper unit can also comprise a plurality of, for example at least two or at least three, braking resistors. “Provided” is in particular to be understood as specifically designed and/or equipped. The fact that an object is provided for a specific function is to be understood in particular to mean that the object fulfills and/or executes this specific function in at least one application and/or operating state.

Preferably, according to an example embodiment of the present invention, the braking chopper unit is arranged between the electric motor and the vehicle battery in terms of circuitry, which makes it possible to achieve an advantageously simple circuit. In particular, the vehicle can comprise power electronics for controlling the electric motor. In this case, the braking chopper unit is preferably electrically connected directly to the power electronics and the vehicle battery.

The braking chopper unit can be designed to be passive and, for example, automatically activated when an operating variable, for example in the form of an intermediate circuit voltage, exceeds a certain limit value. In particular, in this case, the braking chopper unit does not have a control connection for active control, for example by means of a control device. However, it is advantageously proposed that the braking chopper unit is designed to be actively controllable. In this context, the braking chopper unit can preferably comprise at least one controllable switching unit, which can be switched by a switching and/or control signal, for example from a computing unit and/or a control device. Furthermore, in this case the braking chopper unit can also comprise a computing unit electrically connected to the switching unit, in particular a control connection of the switching unit, for providing the switching and/or control signal. In this way, particularly high flexibility can be achieved. In addition, corresponding value- added functions can be implemented particularly easily.

According to a further embodiment of the present invention, it is provided that at least the braking resistor is arranged in an exposed and/or well-ventilated area of the vehicle. This can improve cooling of the braking resistor and/or reduce the mass of the heat sink associated with the braking resistor.

It is also provided that the braking resistor is arranged, in particular on the vehicle or in the vehicle, in such a way that an air flow generated during a driving operation of the vehicle is directed toward the braking resistor. In this case, the vehicle can advantageously also comprise at least one, in particular additional, air guiding element, which is provided for guiding the air flow in the direction of the braking resistor and preferably directly onto the braking resistor. This allows the thermal behavior of the braking resistor to be further optimized.

The braking resistor could be designed as a foil resistor, for example. However, it is particularly advantageous if the braking resistor is designed as a wire resistor, which allows a particularly flexible arrangement of the braking resistor on the vehicle.

According to an example embodiment of the present invention, it is also provided that the vehicle comprises at least one chassis component around which the braking resistor is wound. In particular, if the vehicle is designed as a two-wheeler or three-wheeler, the chassis component can be a swing arm rear suspension or a dashboard, for example. This makes it possible to dispense with additional brackets for the braking resistor.

According to an example embodiment of the present invention, it is also preferably provided that the chassis component functions as a heat sink and is provided for cooling the braking resistor. Preferably, the chassis component consists of a thermally conductive material having a thermal conductivity of at least 100 W/mK and particularly preferably at least 200 W/mK. This makes it possible to dispense with additional heat sinks.

A particularly high level of operational safety can be achieved in particular if the braking resistor is arranged on the chassis component in such a way that contact, in particular by a driver, is excluded during a driving operation.

In addition, according to an example embodiment of the present invention, a method for operating the aforementioned vehicle is provided, wherein excess energy generated by the electric motor during the braking operation is dissipated by means of the braking chopper unit and in particular the at least one braking resistor. In particular, the advantages already mentioned above can be achieved in this way, wherein at least one braking functionality can be improved.

In this case, the vehicle and the method are not intended to be limited to the application and example embodiments described above. In particular, in order to fulfill a mode of operation described herein, the vehicle and the method can include a number of individual elements, components and units that deviates from a number mentioned herein.

### BRIEF DESCRIPTION OF THE DRAWINGS

Further advantages result from the following description of the figures. An exemplary embodiment of the present invention is illustrated in the figures.

FIG. 1 is a simplified representation of an exemplary motor vehicle in the form of a motorcycle and having an electric motor and a vehicle battery.

FIG. 2 is a detailed view of the circuitry of the vehicle.

FIG. 3 is an exemplary flow chart with main method steps of a method for operating the vehicle, according to the present invention.

### DETAILED DESCRIPTION OF EXAMPLE EMBODIMENTS

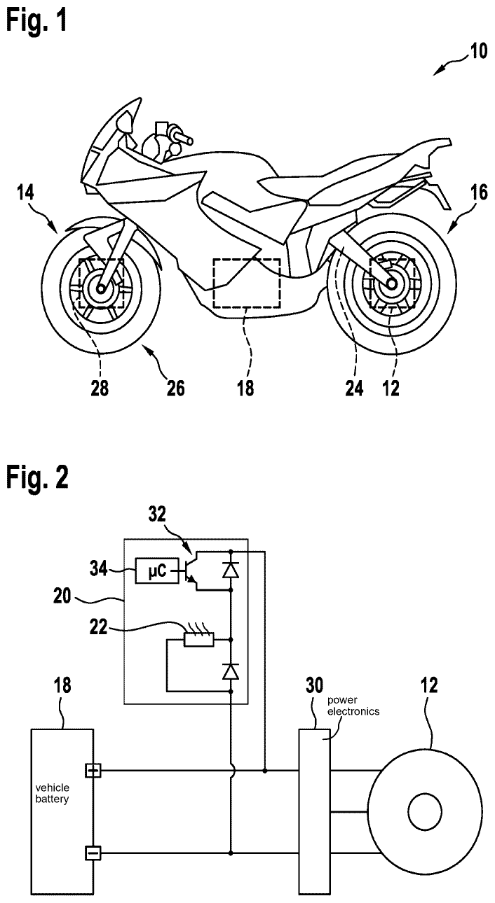

FIG. 1 is a simplified representation of an exemplary vehicle 10 in the form of a two-wheeler. The vehicle 10 is designed as a single-track vehicle and comprises a first vehicle wheel 14 designed as a front wheel and a second vehicle wheel 16 designed as a rear wheel. Furthermore, the vehicle 10 is designed as an electrically driven vehicle or electric vehicle. In the present case, the vehicle 10 is designed as a motorcycle, more precisely as an electric motorcycle. In principle, however, a vehicle could also be designed as a vehicle other than a motorcycle, such as a moped or scooter. A vehicle could also be designed as a three-wheeler, such as a rickshaw. Furthermore, a vehicle could in principle also be designed as a lightweight motor vehicle, such as a quad bike. In addition, a corresponding vehicle could be designed as a hybrid vehicle.

The vehicle 10 comprises an electric motor 12 and a vehicle battery 18 functionally coupled to the electric motor 12. In the present case, the electric motor 12 is assigned to the second vehicle wheel 16 and is designed as a wheel hub motor, for example. The vehicle battery 18 is designed as an accumulator, for example as a lithium-ion accumulator. In addition, the vehicle 10 comprises a hydraulic brake system 26 having at least one hydraulic brake unit 28. The hydraulic brake unit 28 is assigned to the first vehicle wheel 14, while no hydraulic brake unit is assigned to the second vehicle wheel 16 in the present case. In principle, however, a hydraulic brake system could also comprise a plurality of brake units, wherein one of the brake units could be assigned to each vehicle wheel. It is also possible to dispense with a hydraulic brake system altogether. An electric motor could also be assigned to a first vehicle wheel. Furthermore, a vehicle could comprise a plurality of electric motors, wherein one of the electric motors could be assigned to each vehicle wheel. In addition, a vehicle could also comprise a plurality of vehicle batteries.

Furthermore, the vehicle 10 has at least one recuperation operating mode, in which the electric motor 12 is provided for decelerating the vehicle 10 or the second vehicle wheel 16. For this purpose, the electric motor 12 is operated as a generator during a braking operation, so that it generates a recuperative braking torque to decelerate the second vehicle wheel 16. As a result, the kinetic energy of the vehicle 10 is converted into electrical energy during the braking operation by means of the electric motor 12 and stored, for example, in the vehicle battery 18. In addition, the electric motor 12 in the present case is also used to drive the vehicle 10 or the second vehicle wheel 16. For this purpose, the electric motor 12 is operated as a motor in at least one operating state that differs from the braking operation, so that it generates a drive torque to drive the second vehicle wheel 16. The electric motor 12 is therefore provided on the one hand for decelerating the vehicle 10 and on the other hand for driving the vehicle 10. Alternatively, an electric motor could also be used exclusively to decelerate the vehicle or to drive the vehicle.

In the recuperation operating mode described above, the braking power is generally highly dependent on the temperature and state of charge of the vehicle battery 18. Accordingly, if the vehicle battery 18 is too cold, too hot, or has too high a state of charge, it can absorb very little or no energy, as a result of which the electric motor 12 cannot decelerate the vehicle 10 or, in this case, the second vehicle wheel 16, or can only do so insufficiently. In many driving situations, the vehicle battery 18 is therefore the bottleneck for a maximum braking power which the vehicle 10 can regeneratively convert. As a result, very poorly reproducible generative braking behavior is normally achieved, and in many vehicles the generative braking torque is kept very low so that it is not noticeable to the driver when the vehicle battery 18 is at an unfavorable operating point and no electric braking power is possible.

To improve braking functionality, in particular electrical braking functionality, the vehicle 10 has a braking chopper unit 20 (cf. in particular FIG. 2). The braking chopper unit 20 is operatively connected to the electric motor 12 and the vehicle battery 18 and is arranged between the electric motor 12 and the vehicle battery 18 in terms of circuitry. In the present case, the braking chopper unit 20 is electrically connected directly to the vehicle battery 18 on the one hand and electrically connected directly to power electronics 30 of the vehicle 10 for controlling the electric motor 12 on the other hand. The braking chopper unit 20 is provided for dissipating excess energy generated by the electric motor 12 during the braking operation, i.e., energy which is generated by the electric motor 12 during the braking operation and cannot be absorbed and/or stored by the vehicle battery 18, for example due to a current state of charge and/or a current temperature of the vehicle battery 18. In the present case, the braking chopper unit 20 is designed such that only the electric motor 12 is used to decelerate the vehicle 10 or the second vehicle wheel 16 during the braking operation and a hydraulic brake, in particular an additional hydraulic brake on the second vehicle wheel 16, can be dispensed with.

For this purpose, the braking chopper unit 20 comprises at least one braking resistor 22. In the present case, the braking chopper unit 20 comprises exactly one braking resistor 22 as an example. The braking resistor 22 is located in an exposed or at least well-ventilated area of the vehicle 10. In the present case, the braking resistor 22 is arranged on the vehicle 10 or in the vehicle 10 in such a way that an air flow generated during a driving operation of the vehicle 10 is guided in the direction of the braking resistor 22, whereby cooling of the braking resistor 22 can be significantly improved. For this purpose, the vehicle 10 can, for example, comprise at least one, in particular additional, air guiding element (not shown), which is designed and shaped in such a way that an air flow is guided in the direction of the braking resistor 22 and preferably directly onto the braking resistor 22. In principle, however, such an air guiding element can also be dispensed with.

In order to reduce the installation space and thus the cost of the braking resistor 22, the braking resistor 22 in the present case is also designed as a wire resistor and is wound directly around a chassis component 24 of the vehicle 10. The chassis component 24 acts as a heat sink and is provided for cooling the braking resistor 22, so that additional heat sinks are not required. In addition, the braking resistor 22 is arranged on the chassis component 24 in such a way that contact by a driver is excluded during a driving operation. In the present case, the chassis component 24 is, for example, a swing arm rear suspension of the vehicle 10. In principle, however, all chassis components with good heat conducting properties and where contact is excluded during a driving operation, in particular to avoid the risk of burns, are suitable. Alternatively, it is possible to design a braking resistor as a resistor other than a wire resistor, such as a foil resistor and/or a sheet resistor.

Furthermore, in the present case, the braking chopper unit 20 is designed to be actively controllable. For this purpose, the braking chopper unit 20 comprises at least one controllable switching unit 32 and a computing unit 34 interacting with the switching unit 32. Alternatively, however, a braking chopper unit can also be designed to be passive and, for example, automatically activated when an operating variable, for example in the form of an intermediate circuit voltage, exceeds a certain limit value.

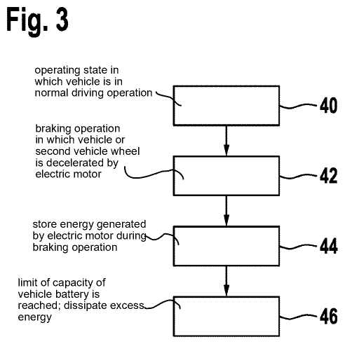

Finally, FIG. 3 is an exemplary flow chart with main method steps of a method for operating the vehicle 10.

A method step 40 corresponds to an operating state in which the vehicle 10 is in normal driving operation. The vehicle 10 can advantageously be driven by the electric motor 12. For this purpose, the electric motor 12 is operated as a motor, so that it generates a drive torque to drive the second vehicle wheel 16.

A method step 42 corresponds to a braking operation in which the vehicle 10 or the second vehicle wheel 16 is decelerated by means of the electric motor 12. For this purpose, the electric motor 12 is operated as a generator during the braking operation, so that it generates a recuperative braking torque to decelerate the second vehicle wheel 16. As a result, the kinetic energy of the vehicle 10 is converted into electrical energy during the braking operation by means of the electric motor 12.

In a method step 44, if possible, the energy generated by the electric motor 12 during the braking operation is first stored in the vehicle battery 18.

In a method step 46, a limit of the capacity of the vehicle battery 18 is reached. In this case, the braking chopper unit 20 and in particular the braking resistor 22 are used to dissipate excess energy generated by the electric motor 12 during the braking operation, i.e., energy which is generated by the electric motor 12 during the braking operation and cannot be absorbed and/or stored by the vehicle battery 18, for example due to a current state of charge and/or a current temperature of the vehicle battery 18.

The exemplary flow chart in FIG. 3 is only intended to describe an exemplary method for operating the vehicle 10. In particular, individual method steps may also vary or additional method steps may be added.

1-10. (canceled)

11. A vehicle, comprising:
at least one electric motor configured to decelerate the vehicle and/or at least one vehicle wheel of the vehicle during a braking operation;
at least one vehicle battery which is functionally coupled to the electric motor; and
a braking chopper unit operatively connected to the electric motor and the vehicle battery, the braking chopper unit including at least one braking resistor, and is configured to dissipate excess energy generated by the electric motor during the braking operation.

12. The vehicle according to claim 11, wherein the vehicle is a two-wheeler or a three-wheeler.

13. The vehicle according to claim 11, wherein the braking chopper unit is arranged between the electric motor and the vehicle battery in terms of circuitry.

14. The vehicle according to claim 11, wherein the braking chopper unit is configured to be actively controllable.

15. The vehicle according to claim 11, wherein at least the braking resistor is arranged in an exposed and/or well-ventilated area of the vehicle.

16. The vehicle according to claim 11, wherein the braking resistor is arranged in such a way that an air flow generated during a driving operation of the vehicle is directed toward the braking resistor.

17. The vehicle according to claim 11, wherein the braking resistor is a wire resistor.

18. The vehicle according to claim 17, further comprising at least one chassis component around which the braking resistor is wound.

19. The vehicle according to claim 18, wherein the chassis component functions as a heat sink and is provided for cooling the braking resistor.

20. The vehicle according to claim 17, wherein the braking resistor is arranged on the chassis component in such a way that contact by a driver of the vehicle is excluded during a driving operation.

21. A method for operating a vehicle, the vehicle including:
at least one electric motor configured to decelerate the vehicle and/or at least one vehicle wheel of the vehicle during a braking operation;
at least one vehicle battery which is functionally coupled to the electric motor; and
a braking chopper unit operatively connected to the electric motor and the vehicle battery, the braking chopper unit including at least one braking resistor, and is configured to dissipate excess energy generated by the electric motor during the braking operation;
the method comprising:
dissipating excess energy generated by the electric motor during the braking operation using the at least one braking resistor of the braking chopper unit.
